(19) United States
(12) Patent Application Publication
(10) Pub. No.: US 2008/0144164 A1
(43) Pub. Date: Jun. 19, 2008

(54) Device for Generating Laser Impulses Amplified by Optical Fibres Provided with Photon Layers

(75) Inventor: Phillippe Metivier, Corenc (FR)

Correspondence Address: Young & Thompson, 745 S. 23rd Street., Second Floor, Arlington, VA, 22202, US

(73) Assignee: EOLITE SYSTEMS, Pessac (FR)

(21) Appl. No.: 11/912,049

(22) PCT Filed: Apr. 19, 2006
(86) PCT No.: PCT/FR2006/050358

§ 371 Date: Oct. 19, 2007

(30) Foreign Application Priority Data
Apr. 19, 2005 (FR) 05.50997

(51) Int. Cl. H01S 3/00

(52) U.S. Cl. 359/341.32

(57) ABSTRACT

A device for generating amplified laser pulses includes at least one pulse laser controlled by at least a switch unit transmitting a master laser beam spatially multiplexed into elementary laser beams which are amplified in parallel by at least two optical amplifiers, wherein each of the amplified elementary laser beams is directed towards a single focussing volume. Each optical amplifier includes a fibre with photon layers, at least one optical pumping unit laser diode producing at least one pump wave for longitudinally pumping the fibre and one element for focussing in the focussing volume the amplified beam generated by the fibre, the silica or glass elongated fibre including a doped core, the pumping of each optical amplifier is continuous and the generation of the amplified optical pulses is obtained directly by the pulse laser.

The present invention relates to a device for generating amplified laser pulses by optical fibres with photon layers. These laser pulses are into the time range of the nanoseconds and the energy range of the multi-millijoules. It finds application in particular in the realisation of secondary sources by plasma energization in the fields where electromagnetic radiations of very short wavelength, for instance ultraviolet possibly X, must be obtained as for example for the photolithography of manufacture of components in electronics.

The race of integration in the electronics field leads to the realisation of structures of smaller and smaller electronic chips. These structures are performed by photolithography and the reduction in size requires the use of electromagnetic sources with shorter and shorter wavelengths towards the extreme ultraviolet, possibly the X rays. Plasmas are one of the means for realising such sources with short wavelength.

In the field of lasers are known optical amplifiers with glass fibre formed of a doped core and of at least one peripheral sheath ensuring the guiding of a produced wave. The core is doped by a rare earth ion, neodymium or ytterbium generally. The guiding is ensured by the implementation of a photon structure obtained by a geometrical assembly of channels or aerial capillaries (holes). This structure lowers artificially the index seen by the wave produced and enables mono-mode propagations for fibre core diameters of the order of 50 μm. This large core diameter enables to spread the energy of the wave produced over a greater surface and to push back both fundamental limitations of fibre amplifiers, i.e. flow handling and non-linear effects. Such a technology enables to contemplate the production of laser pulses with energies of the order of 1 mJ to 10 mJ while keeping short pulse durations thanks to the design of this fibre which enables to obtain the laser gain over typical fibre lengths smaller than 1 m. Such a fibre here designated as laser fibre with photon layers or MPF (for multiclad photonic fibre) has been presented in the article by J. Limpert, N. Deguil-Robin, 1. Manek-Honninger, F. Salin, F. Röser, A. Liem, T. Schreiber, S. Nolte, H. Zellmer, A. Tünnermann, J. Broeng, A. Petersson, and C. Jakobsen, “High-power rod-type photonic crystal fibre laser,” Opt. Express 13, 1055-1058 (2005).

The difference made by the man of the art between a solid-state laser and a fibre laser may be reminded here. To this end, the following documents may be quoted: BABUSHKIN et al, Proc. SPIE 2005 Vol 5709 page 98 in the introduction; Patent FR 2 859 545 (CEA) on page 9 lines 25-32 and page 13 line 32; or still, HEADLEY et al, Proc. SPIE 2005 Vol 5709 page 343, at the first 5 lines of the insertion. It appears clearly that a solid-state laser designates commonly a laser whereof the amplifying medium is a massive solid (crystalline or vitreous) in the form of a homogeneous block of material with dimensions at least of the order of the millimetre (generally called bar) wherein the laser wave propagates freely whereas a fibre laser obviously involves an amplifying medium in the form of a waveguide with micrometric dimensions wherein the laser wave undergoes forcible guiding. Still, the shape of the wave transmitted by the laser is fastened by the resonator and, In the case of a solid-state laser, it undergoes hence the thermal effects in the bar whereas the wave transmitted by a fibre laser keeps all the guiding properties of the fibre (a transversal mono-mode wave in the case of a mono-mode fibre and transversal multi-mode for a multi-mode fibre). There is hence a fundamental difference between a device involving a fibre laser and a solid-state laser.

Besides, the state of the art shown by the Patent Applications of CEA FR-2 814 599 or FR-2 859 545, underlines the possibility of associating in parallel several pumped solid-state lasers so as to multiply the luminous density at the focal point of a target and so as to obtain globally important pulse energies which are conveniently impossible to obtain with conventional monolithic solid structures ensuring simultaneously such levels of energy and a required beam quality.

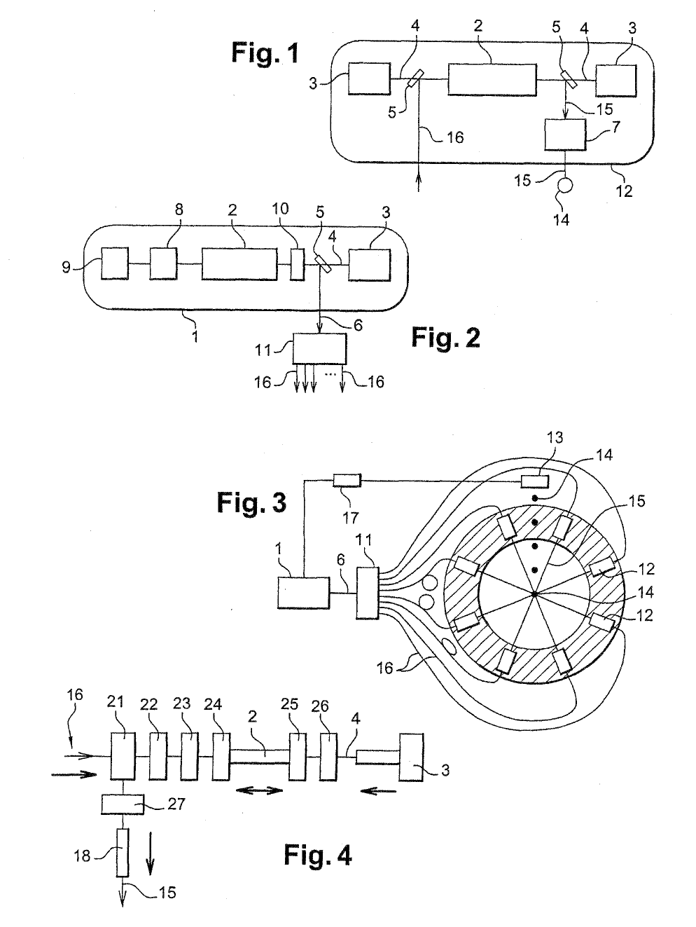

Other documents of the state of the art are also known which are stated below:
U.S. Pat. No. 5,790,574 (1998—JMAR) relating to a modelocked source (<<modelocked laser>>) and which product picosecond pulse streams whereof the focussing point is modified at very high speed by a PZT system. The source, like the amplifiers, exhibits a very conventional laser bar structure (in particular made of Nd:HAG). On FIG. 1 of this document, the master laser is a modelocked laser and the pulses have sub-nanosecond durations. On the other hand, the pulses are doubled in frequency before being focussed. Moreover the different beams form a slight angle therebetween and are hence not focussed at a single spot. Their light intensities may hence not be added which imposed to each beam to reach the minimum required for the production of X radiation.
The article JVS&T January 2003 Vol 21 nl pages 280-287 (GAETA & Co—JMAR) relates to a solid-state laser Nd:YAG which does not include any fibred amplifier. The duration of the pulses is sub-nanosecond. The repeat rate is 300 Hz. The on-target intensity is of the order of 3.10¹⁴ W/cm², which is approx. 10,000 times too high for the production of 13.5-mm EUV radiation.
Article Proc. SPIE 2004 Vol 5620 pages 137-146 (TUNNERMANN & Co—Univ Jena) provides detailed results on the MPF (Multiclad Photonic Fibre) technology. The assembly of the results relates to lasers with a single channel (linear structure) and does not mention the possibility of using amplifiers in parallel.
Article OPTICS EXPRESS April 2004 Vol 12 n7 pages 1313-1319 (LIMPERT & Co—Univ Jena) exhibits a solution for amplifying picosecond pulses from the MPF technique. As for the previous document, the amplifiers are not placed in parallel.
Article Proc. SPIE 2005 Vol 5709 pages 98-102 (BABUSHKIN-1PG) exhibits a fibre laser solution with a current-driven semi-conducting diode for transmitting directly the pulse width requested, this diode pulse being then pre-amplified then amplified by conventional fibre amplifiers for generating a laser pulse having a peak power of several ten kW. The amplifier has a linear structure (a single arm) and does not mention the possibility of increasing the multiplying power of the amplifying arms.
Article Proc. SPIE 2005 Vol 5709 pages 133-141 (PAYNE-Southampton univ.) exhibits a coherent recombination solution of fibre lasers, oriented exclusively towards the power-up for continuous and coherent beams. This item exhibits the theoretical possibility of multiplexing a master beam so as to amplify each channel with a photon fibre amp. These different beams are then re-combined coherently, which involves controlling finely the relative phase of the beams. This presentation is synthetised by FIG. 2 which shows a master laser whereof the frequency stability is ensured by a DFB source with a 60-kHz spectral width which is then pre-amplified before spatial multiplexing. The pattern reveals that the difference between the optical paths of the multiplexed beams must remain smaller than the coherence length of the master laser.
Articles OPTICS EXPRESS April 2003 Vol 11 n7 pages 818-823 (LIMPERT & Co IENA) and OPTICS EXPRESS February 2005 Vol 13 n4 pages 1055-1058 (LIMPERT & Co—CELIA) exhibit the results that may be obtained with a short MPF fibre.

Article HEADLEY, SPIE January 2005 No 5709 p 343-353 exhibits a pulse amplifying method using index hopping multimode fibres and a coupling of the pump by fibre packages. The difficulty of obtaining monomode propagation in a large core index hopping fibre is emphasised and on-line amplification structure is presented. The article alludes briefly to photonic fibres to rule out their use.
FR 2 859 545 (CEA) concerns the parallel-setting of solid-state lasers synchronised by electronic means (active synchronising).
Article JOAP January 1999 vol 85, no 2 Page 672—(LIN et Al—Univ Essex) mentions the interest of generating a pre-pulse before a main pulse for pumping a plasma so as to realise an X-rays laser at 7.3 nm.
US 2004/002295 (Weulersse-CEA) concerns the implementation of at least three massive lasers synchronised electronically (active synchronising).
EP 1 041 686 (TRW) relates to the realisation of a high power planar wave by coherent re-combination coupled to a spatial phase detector. The final beams are not synchronised and the emissions are continuous.

This invention offers a high power laser source in pulse mode, integrated multi-millijoules in nanosecond rate which exhibits numerous advantages with respect to the devices known and which enables moreover, in particular, the realisation of secondary sources of electromagnetic radiations by plasma excitation or non-linear crystal excitation so as to generate such electromagnetic radiations by using said laser source as a primary excitation means. This advantage is obtained by implementing a distributed amplification over several photonic fibres (MPF) enabling to take benefit from the advantages relating to photonic fibres and the usage of a parallel architecture.

The source of the invention includes a master laser operating in rhythm (oscillator) triggered by at least one switch unit whereof the transmitted beam is distributed (multiplexed) into N sub-sources which are distributed to N optical amplifiers of the photoclad fibre type (MPF) pumped, wherein each of the amplifiers is pumped by laser diodes and re-transmits an optical beam towards a single focussing volume common to the N amplifiers. The focussing volume may correspond to a solid, liquid or gaseous material, which will be thus excited for the secondary generation of a source at a wavelength different from that of the laser triggered. The master laser is a high rate pulse oscillating laser using for instance a photoclad fibre (MPF).

Thus, the invention relates to a device for generating amplified laser pulses comprising at least one pulse laser controlled by at least one switch unit transmitting a master laser beam spatially multiplexed into elementary laser beams which are amplified in parallel by at least two optical amplifiers, wherein each of the amplified elementary laser beams is directed towards a single focussing volume.

According to the invention, each optical amplifier includes a fibre with photon layers, so-called MPF, at least one laser diode optical pumping means producing at least one pump wave for longitudinally pumping said fibre and one means for focussing in the focussing volume the amplified beam generated by the fibre, the silica or glass elongated fibre including a doped core, a first peripheral layer with laser wave guiding photon structure surrounded with a pump wave confining layer, the confining layer being surrounded with a sheath, the guiding and the confinement are obtained by implementing aerial capillaries within the fibre, the pumping of each optical amplifier being continuous and the generation of the amplified optical pulses being obtained directly by a pulse laser operating in rhythm, said device having a configuration of the multiplexing, of the parallel amplification and of the focussing of each beam enabling to guarantee the synchronising of the optical pulses produced by the assembly of the fibre optical amplifiers so that they come up according to a predetermined time sequence in the focussing volume.

In various embodiments of the invention, the following means may be used on their own or according to all technically possible combinations, are used:
each optical amplifier has one fibre with photon layers of a length smaller than 1 m,
the amplified elementary laser beams are each very close to the diffraction limit,
the amplified elementary laser beams exhibit each a parameter M² smaller than 2,
the pulse laser transmitting a master laser beam which is then spatially multiplexed then amplified by optical amplifiers is a pulse laser with amplifying fibre with photon layers (MPF).
the device includes a pulse laser oscillator producing the master laser beam followed by at least two parallel optical amplifiers, (the pulse laser with its switch means is an oscillator)
the assembly includes between two and one hundred parallel optical amplifiers,
the repeat frequency of the laser pulses is at least 10 kHz,
the duration of the laser pulses produced by each of the optical amplifiers ranges between 1 ns and 30 ns,
the duration of the laser pulse at the focussing spot ranges between Ins and 100 ns,
the average power in the focussing volume is at least 1 kW,
the average power in the focussing volume is at least 3 kW,
the focussing volume corresponds to the intersection zone of the amplified elementary laser beams and exhibits a volume smaller than 1000 μm cubic,
the focussing volume is a substantially spherical or ovoid zone where at least 90% of the laser energy is concentrated in a volume smaller than 1000 μm cubic,
the amplified elementary laser beams products by the assembly of the optical amplifiers are focussed according to a spherical geometry wherein the target is situated in the centre of the sphere perpendicular to the assembly of the incident beams,
the incident beams form a ring around the focussing volume, (the beams are distributed over a circumference of the sphere corresponding to the focussing volume, i.e. in case when there is a focussing along a spherical geometry)
the density of energy at the focussing spot per pulse is at least 1.10¹⁰ W/cm²,
the stability of the energy of the pulses is at least 1% at 3 σ,
the device includes moreover means for generating a plasma transmitting an electromagnetic radiation into the range of the extreme ultraviolet of wavelength of approximately 13.5 nm,
the ends of the guided portion (ends of the amplifying fibres) of the amplified laser beams are arranged in the space around the focussing volume,
the ends of the guided portion (ends of the amplifying fibres) of the amplified laser beams are arranged substantially at the same distance around the focussing volume, (the ends of the amplifying MPF fibres towards the focussing volume are arranged substantially at the same distance around the focussing volume)
the ends of the guided portion (ends of the amplifying fibres) of the amplified laser beams are arranged diametrically in twos, opposite to one another, around the focussing volume, (the ends of the amplifying MPF fibres towards the focussing volume are arranged diametrically in twos, opposite to one another, around the focussing volume)
the ends of the guided portion (ends of the amplifying fibres) of the amplified laser beams are arranged around the focussing volume so that no amplified laser lies opposite to one another amplified laser beam, (to prevent from any possible destruction of a laser source by injection of an amplified laser beam in another opposite to one another amplifying fibre),
the ends of the guided portion (ends of the amplifying fibres) of the amplified laser beams are arranged radially equi-angularly around the focussing volume in a same plane
each fibre includes a dynamic tracking system so as to provide the same focussing spot of each beam independently of the environmental constraints,
the dynamic tracking system includes two angularly adjustable mirrors, position and direction detectors of the amplified laser beam arranged downstream of said mirrors and means for controlling the orientation of the mirrors according to the error signal provided by the detectors,
the detectors are (for instance) four quadrant detectors, wherein one of the detectors is placed at the focal point of a focussing means so as to be sensitive to the direction of the incident beam,
the pumping means of each optical amplifier includes at least one laser diode source transmitting a pump wave returned longitudinally into the fibre by a dichroic mirror (or any other equivalent optical element) enabling to inject simultaneously in the optical amplifier the elementary laser beam derived from the pulse laser and the pump,
the pumping means includes at least one laser diode source transmitting a pump wave, wherein the pump wave is injected longitudinally into the fibre via a dichroic mirror, wherein the corresponding elementary laser beam may be injected into said fibre thanks to said dichroic mirror,
the pumping means enables to send into the amplifying fibre a pump wave at one end of said fibre,
the pumping means enables to send into the amplifying fibre two pump waves, i.e. a pump wave at each of each of both ends of said fibre,
the pumping means enables to send into the amplifying fibre two pump waves polarised perpendicular to one another at one end of said fibre,
the fibre of the optical amplifier is used in double pass for the amplified laser beam, the separation between the incident wave and the emerging wave of the amplifier is carried out by a means for separating the polarisation,
the MPF fibre amplifier is used in double pass, the master laser beam entering the MPF fibre through the same end as that through which the amplified beam exits, the pump wave(s) being sent into the fibre by the other end of the MPF fibre,
the oscillator pulse laser is formed of a switch means and of an amplifying medium of MPF type, (amplifying the signal thanks to the MPF configuration)
the oscillator pulse laser transmitting a master laser beam is then spatially multiplexed then amplified by optical amplifiers is a pulse laser with amplifying fibre with photon layers (MPF).
the oscillator laser is moreover followed by an amplifier module with MPF photon fibre producing the master laser beam,
the device includes a pulse laser,
the device includes at least two pulse lasers time-synchronised to one another, each transmitting (directly or via an MPF photon fibre amplifier module) a spatially multiplexed master laser beam towards at least two parallel optical amplifiers,
the master laser beam is multiplexed spatially then connected to the different optical amplifiers by optical guides (guiding optical fibres) whereof the lengths are determined so that the pulses of the amplified elementary laser beams produced by the assembly of the optical amplifiers come up in the focussing volume according to a predetermined time pattern,
the amplified elementary laser beam of each optical amplifier is connected to the focussing volume by a non-amplifying transport photon fibre whereof the length and the configuration are determined so that the pulses of the amplified elementary laser beams produced by the assembly of the optical amplifiers come up in the focussing volume according to a predetermined time pattern.

The notions of mode and diffraction limit relating to each beam amplified elementary laser are known to the man of the art, but if necessary one may refer to article <<Laser Beams and Resonators>> by 14. Kogelnik and T.Li in APPLIED OPTICS/Vol. 5, No 10/October 1966, p. 1550-1567

The device enables mainly to have a very good beam quality (close to the diffraction limit for each amplifying channel), for a very high power density (1 mJ to 10 mJ per channel) associated with a high repeat rate (10 KHz to 100 KHz). The device of the invention also enables to have a very high average energetic stability in the focussing volume thanks to a shooting rate (pulse) of at least 10 KHZ and thanks to the multiplicity of the elementary sources ranging generally from 10 to 100 according to the configurations. Moreover, the complexity of the device is not proportional to the power-up obtained in the focussing volume thanks to the parallel architecture. Finally, because of the large number of sources used, the device may have particularly high usage ratio, wherein the non-operation of one, possibly a few sources, only reduces the average power marginally.

The device also enables to have a very high flexibility in the optical features in the focussing volume since by modifying the distance (length or type of optical path—optical guiding or transport fibre as the case may be) separating the oscillator (master pulse laser) and certain optical amplifiers it is possible to produce time profiles with complex energy (creation of a pre-pulse for instance).

The present invention will now be exemplified without being limited thereto with the following description in relation with the Figures below:

FIG. 1 which represents a first example of MPF fibre optical amplifier implemented in the device of the invention for amplifying each elementary laser beam,

FIG. 2 which represents the pulse laser and the spatial multiplexing of the master laser beam into elementary laser beams intended for being amplified by optical amplifiers,

FIG. 3 which represents an example of embodiment of the device,

FIG. 4 represents a second example of MPF fibre amplifier, of the double pass and polarisation separation type.

The MPF fibres enable to realise laser sources over 100 W in average power each while keeping a beam quality close to the diffraction, wherein the only amplified mode being the fundamental mode TM00 (transversal monomode). This good beam quality enables relatively thin focussing, deposition of the maximum of energy over approx. 10 μm in diameter at the focussing spot and enables to energise a target (particle) of a few microns (approx. from 5 μm to 20 μm) in diameter. The global shape of the focussing spot is very approximately spheroidal and depends on the relative orientations of the laser beams to one another.

Generally speaking, an MPF fibre is a glass or silica elongated structure with an axial geometry including in the centre a doped amplifying medium wherein the amplified radiation will be guided and, around this amplifying medium, a guiding sheath of photonic type (i.e. exhibiting a “punched” structure lowering artificially the index of the material of the guiding sheath). Around the guiding sheath is situated a pump sheath enabling to confine the pump wave into the guiding sheath and the core. Preferably, around this structure, an additional sheath is available liable to act as a protection (mechanical stiffener and/or thermal radiator). This type of MPF fibre is characterised in particular in that core diameters of 30 μm to 100 μm may be obtained while having a monomode guiding and a digital aperture greater than 0.6 for the pump sheath, which facilitates the longitudinal injection of the pump wave(s). The pump guiding zone is slightly greater than approximately 100 μm in diameter and may be widened in relation to the maximisation of the laser. These diameter values are suited to the needs but they have an influence on the length of the fibre necessary to the amplification. The typical length of an amplifier based upon such an MPF fibre is smaller than 1 m.

So as to obtain gain in the MPF fibre, the core is doped with Ytterbium ions. These ions are energised by pumping using power laser diode. The Ytterbium is interesting in that it can be pumped at 980 nm, a wavelength corresponding to the amplifiers used conventionally in telecommunications, which guarantees the supply and the improvement of the pumping diode technologies. These diodes have too small a brightness for the pump wave to be injected directly into the core of the fibre and hence the pump guiding capacity of the fibre is used for propagating the power of the pump wave towards the core. The implementation of these MPF fibres is relatively simple since it is possible to obtain significant powers without resorting necessarily to using cooling means, wherein this type of fibre was capable of sustaining pump powers greater than 300 W.

The amplifiers implemented in the device use such MPF fibres and may be each pumped by one or both their ends by pumping means, which enables to double the pump power injected longitudinally into the fibre. In a variation implementing a polarisation of the pump wave the pump power injected into the fibre may be quadrupled by using at each end two pump waves with crossed polarisations.

Preferably and as represented on FIG. 1, the pumping means 3 of the optical amplifier 12 produce at each end of the MPF fibre 2 pump waves 4 whereof the optical axis is parallel to the MPF fibre 2. The pump waves 4 are sent longitudinally into the fibre via dichroic mirrors 5 capable of reflecting the corresponding elementary laser beam 16 which is amplified in the optical amplifier 12. The amplified elementary laser beam 15 is also reflected by a dichroic mirror 5 and is then sent through a focussing means 7, opto-mechanical preferably, towards a target 14. Preferably, the MPF fibre 2 (or an additional optical element) returns preferably the amplified elementary laser beam 15 towards the dichroic mirror in relation with the focussing means 7 and not towards the multiplexer 11 which will be seen in relation with FIG. 2.

Thus the amplifier represented on FIG. 1 includes an MPF 2 fibre which is pumped at both its ends by two pumping means 3 of the laser diode type, themselves fibred (the pump wave is sent towards the amplifying fibre MPF via an optical guide of the optical fibre type), producing two pump waves 4 substantially parallel to the fibre 2 and sent back longitudinally into the fibre 2 via dichroic mirrors 5 transmitting the pump wave, but reflecting the elementary laser beam 16 which is amplified into the MPF fibre 2 and exits amplified 15 for being directed and focussed on the target 14 by an opto-mechanical means 7.

In another configuration represented on FIG. 4, the MPF fibre amplifier is used in double pass. An incident wave of elementary laser beam 16 from the master laser is injected in the amplifier through a polarisation separation means 21. The incident wave of the master laser is polarised linearly. The wave then runs through a quarter wave blade 22 which transforms the linear polarisation into a circular polarisation. This wave is then injected into the MPF fibre 2 using optical means 23. A dichroic optical means 24 transmitting the wave from the master laser and capable of reflecting the pump wave may optionally be inserted on the path. The MPF fibre 2 possesses an external sheath of large diameter (>1 mm) conferring high rigidity thereto. This rigidity enables to maintain the polarisation of the incident wave. A dichroic optical means 25 reflects the wave from the master laser and is capable of transmitting the pump wave produced by the module 3 and which is introduced by means of an optical coupling element 26 against or on the outlet face of the fibre. The wave is hence returned to itself via the fibre. A second passage through the quarter wave blade transforms the circularly polarised wave into a linearly polarised wave but whereof the polarisation direction is perpendicular to that of the incident wave from the master laser. This wave is separated from the incident wave by the polarisation separator 21 and may be re-focussed by an optical means 27 in a transport guide 18 which may be a flexible photon fibre. Such an implementation enables to increase significantly the gain of the amplifier and hence to decrease the power of the incident wave from the master laser.

Generally speaking, the oscillator pulse laser may be:
a laser diode transmitting continuously and whereof the radiation is pulse-modulated by an external high frequency modulator, wherein the pulses may moreover be amplified in an MPF fibre amplifier arranged downstream of the modulator before the multiplexer,
a laser diode whereof the power supply current is modulated and which may be followed by an optical amplifier with MPF fibre before the multiplexer,
a laser triggered (wherein itself may be an MPF fibre laser) by active or passive means and whereof the transmission time may be preferably synchronised on an external clock.

It is the latter type of laser oscillator 1 which is represented on FIG. 2 and which integrates pumping means 3 producing the pump wave 4 whereof the optical axis is parallel to the MPF fibre 2, wherein the pump wave 4 is sent longitudinally into the fibre 2 via a dichroic mirror 5 capable of reflecting the laser wave propagating in the laser resonator. Mirrors 9 and 10 form a tuned optical cavity and a switch means 8 (an electro-optical crystal, or any other means enabling rapid modulation) is arranged in the cavity. The laser cavity is thus formed of a totally reflecting element 9 and a partially reflecting element 10 for letting out the master laser beam 6. Quite particularly, the partially reflecting element 10 is formed of the face of the fibre. The master laser beam 6 is multiplexed by a spatial multiplexer II (and possibly temporal) for producing the elementary laser beams 16. An MPF fibre optical amplifier may, in a variation, be implemented upstream of the multiplexer 11, at output of the laser oscillator 1 for amplifying the master laser beam 6 before multiplexing.

The device of FIG. 3 implements an assembly of optical amplifiers 12 with MPF fibres 2 of the type of that of FIG. 1 or of FIG. 4 but limited here, by reason of simplification of Figure, to 8 optical amplifiers. These optical amplifiers 12 are arranged on a support in the form of a planar or slightly conical crown and their laser beams converge towards a single focussing volume placed substantially in the centre of the crown. This geometry of laser beams exhibits a cylindrical axis of symmetry and a jet of particles is sent substantially perpendicular to this crown towards the focussing volume.

A means 13 for generating a jet of particles or droplets 14 of tin or xenon by approximately 10 μm in diameter each is arranged so that the jet flows through the focussing volume of the amplified laser beams 15. Preferably, in the jet, the particles or droplets are isolated from one another. A master laser 1 with a switch means producing light pulses is used. The light pulses of the elementary laser beams 16 are sent over optical guides, flexible guiding optical fibres or any other beam carrying optical means, to each of the optical amplifiers 12, the length of the guiding optical fibres being such that with the arrangement of the source 1 and of the amplifiers 12 selected, the laser pulses of the amplified laser beams 15 all come up substantially at the same time in the focussing volume or, more generally, according to a predetermined time pattern.

Thus, the master laser beam is multiplexed spatially then connected to the different optical amplifiers by guiding optical fibres whereof the lengths are determined so that the pulses of the amplified elementary laser beams produced by the assembly of the optical amplifiers come up in the focussing volume according to a predetermined time pattern. In particular, it can be seen on FIG. 3 that certain amplifiers may be physically situated further away from the oscillator than others. Then this variation in distance is compensated for by introducing optical paths which are different for each amplifier. The path may for instance be the longer that the amplifier is situated close to the oscillator so as to ensure synchronous arrival of the pulses transmitted by the different amplifiers on the target situated in the centre of the common focussing volume. In another particular case, one or several optical paths are deliberately selected as different from the others so that the pulses along these paths come up on the target with a lead over the assembly of the others. These “pre-pulses” create a pre-plasma which may be used for changing the interaction conditions of the group of main pulses with the target. For instance the electronics density of the target may be modified for changing its absorption. The temporal offset between both groups of pulses is selected in relation to physical principles of the interaction which are conventionally known. More complicated temporal patterns may be obtained by modulating each optical path independently, either statically (the length of the guiding and/or transport fibres is constant), or dynamically (adjustable lag means).

It has also been stated that in a variation, the amplified elementary laser beam of each optical amplifier is connected to the focussing volume by a non-amplifying transport photon fibre whereof the length and the configuration are determined so that the pulses of the amplified elementary laser beams produced by the assembly of the optical amplifiers come up in the focussing volume according to a predetermined time pattern. The non-amplifying photonic fibres downstream of the optical amplifiers are hence also a means for varying the arrival time of the optical pulses amplified in the focussing volume. When using such non-amplifying photonic fibres, the focussing means used for decreasing (focus) the diameter of each beam up to its diffraction limit is placed after the corresponding non-amplifying photon fibre (then called transport fibre).

A synchronising means 17 is such that the laser pulses come up at the focussing spot where a tin or xenon particle 14 is situated. The latter synchronising is obtained either by detection of the particles or by synchronous generation of the laser pulses and of the particles by the particle generation means 13.

The energy of the laser pulses delivered to the tin or xenon particles is such that plasma is created from which an end ultraviolet electromagnetic radiation may be extracted at approximately 13.5 nm of wavelength. This radiation may then be used for photolithography.

In practice, with 25 sources of 200 W synchronised so that the laser pulses come up at the same location, in the focussing volume, at the same time, one may obtain an average power of 5 kW.

It should be understood that other configurations of MPF fibre laser optical amplifiers are possible and for instance by distribution in the space of the laser amplifiers on several crowns of identical diameters or not but with the same centre corresponding to the focussing volume

1. A device for generating amplified laser pulses comprising at least one pulse laser (1) controlled by at least one switch unit transmitting a spatially multiplexed master laser beam into elementary laser beams (16) which are amplified in parallel by at least two optical amplifiers (12), each of the amplified elementary laser beams (15) being directed towards a single focussing volume,
characterised in that each optical amplifier (12) includes a fibre with photon layers (2), so-called MPF, at least one laser diode optical pumping means (3) producing at least one pump wave (4) for longitudinally pumping said fibre (2) and a means (7) for focussing in the focussing volume the amplified beam (15) generated by the fibre, the silica or glass elongated fibre including a doped core, a first peripheral layer with laser wave guiding photon structure surrounded with a pump wave confining layer, the confining layer being surrounded with a sheath, the guiding and the confinement are obtained by implementing aerial capillaries within the fibre, the pumping of each optical amplifier is continuous and the generation of the amplified optical pulses is obtained directly by the pulse laser operating in rhythm (1), said device having a configuration of the multiplexing (11), of the parallel amplification (12) and of the focussing (7) of each beam enabling to guarantee the synchronising of the optical pulses produced by the assembly of the fibre optical amplifiers so that they come up according to a predetermined time sequence for a duration ranging between 1 and 100 ns in the focussing volume.

2. A device according to claim 1, characterised in that each optical amplifier has one fibre with photon layers (2) of a length smaller than 1 m.

3. A device according to claim 1, characterised in that the amplified elementary laser beams (15) are each very close to the diffraction limit and each exhibit a parameter M² lower than 2.

4. A device according to claim 1, characterised in that the repeat frequency of the laser pulses is at least 10 kHz, the duration of the laser pulses produced by each of the optical amplifiers ranges between ins and 30 ns and the average power in the focussing volume is at least 3 kW.

5. A device according to claim 1, characterised in that the focussing volume corresponds to the intersection zone of the amplified elementary laser beams (15) and exhibits a volume lower than 1000 μm cubic.

6. A device according to claim 4, characterised in that it comprises moreover means (13, 14) for generating a plasma transmitting an electromagnetic radiation into the range of the extreme ultraviolet of wavelength of approximately 13.5 nm.

7. A device according to claim 1, characterised in that the pumping means (3, 5) includes at least one laser diode source transmitting a pump wave (4), wherein the pump wave is injected longitudinally into the fibre (2) through a dichroic mirror (5), wherein the corresponding elementary laser beam (16) may be injected in said fibre (2) thanks to said dichroic mirror.

8. A device according to claim 7, characterised in that the pumping means (3, 5) enables to send into the amplifying fibre two pump waves (4), i.e. a pump wave at each of both ends of said fibre.

9. A device according to claim 1, characterised in that the fibre (2) of the optical amplifier is used in double pass for the amplified laser beam, wherein the separation between the incident wave and the emerging wave of the amplifier is carried out by a means for separating the polarisation (21).

10. A device according to claim 1, characterised in that the pulse laser (1) transmitting a master laser beam which is then spatially multiplexed then amplified by optical amplifiers is a pulse laser with amplifying fibre with photon layers (MPF).

11. A device according to claim 1, characterised in that the master laser beam is multiplexed (11) spatially then connected to the different optical amplifiers by guiding optical fibres whereof the lengths are determined so that the pulses of the amplified elementary laser beams (15) produced by the assembly of the optical amplifiers (12) come up in the focussing volume according to a predetermined time pattern.

12. A device according to claim 1, characterised in that the amplified elementary laser beam (15) of each optical amplifier (12) is connected to the focussing volume by a non-amplifying transport photon fibre (18) whereof the length and the configuration are determined so that the pulses of the amplified elementary laser beams produced by the assembly of the optical amplifiers come up in the focussing volume according to a predetermined time pattern.

13. A device according to claim 2, characterised in that the amplified elementary laser beams (15) are each very close to the diffraction limit and each exhibit a parameter M² lower than 2.

14. A device according to claim 2, characterised in that the repeat frequency of the laser pulses is at least 10 kHz, the duration of the laser pulses produced by each of the optical amplifiers ranges between ins and 30 ns and the average power in the focussing volume is at least 3 kW.

15. A device according to claim 3, characterised in that the repeat frequency of the laser pulses is at least 10 kHz, the duration of the laser pulses produced by each of the optical amplifiers ranges between ins and 30 ns and the average power in the focussing volume is at least 3 kW.

16. A device according to claim 2, characterised in that the focussing volume corresponds to the intersection zone of the amplified elementary laser beams (15) and exhibits a volume lower than 1000 μm cubic.

17. A device according to claim 3, characterised in that the focussing volume corresponds to the intersection zone of the amplified elementary laser beams (15) and exhibits a volume lower than 1000 μm cubic.

18. A device according to claim 4, characterised in that the focussing volume corresponds to the intersection zone of the amplified elementary laser beams (15) and exhibits a volume lower than 1000 μm cubic.

19. A device according to claim 5, characterised in that it comprises moreover means (13, 14) for generating a plasma transmitting an electromagnetic radiation into the range of the extreme ultraviolet of wavelength of approximately 13.5 nm.

20. A device according to claim 2, characterised in that the pumping means (3, 5) includes at least one laser diode source transmitting a pump wave (4), wherein the pump wave is injected longitudinally into the fibre (2) through a dichroic mirror (5), wherein the corresponding elementary laser beam (16) may be injected in said fibre (2) thanks to said dichroic mirror.
